(19) United States
(12) Patent Application Publication
(10) Pub. No.: US 2015/0247461 A1
(43) Pub. Date: Sep. 3, 2015

(54) GEARED TURBOFAN WITH HIGH FAN ROTOR POWER INTENSITY

(71) Applicant: UNITED TECHNOLOGIES CORPORATION, Hartford, CT (US)

(72) Inventors: Frederick M. Schwarz, Glastonbury, CT (US); Anthony R. Bifulco, Ellington, CT (US)

(21) Appl. No.: 14/430,606

(22) PCT Filed: Mar. 6, 2013
(86) PCT No.: PCT/US2013/029321

§ 371 Date: Mar. 24, 2015

Related U.S. Application Data
(60) Provisional application No. 61/708,106, filed on Oct. 1, 2012.

(51) Int. Cl. F02C 7/36; F02C 3/10

(52) U.S. Cl. CPC F02C 7/36; F02C 3/10

(57) ABSTRACT

A gas turbine engine includes a fan rotating structure including a plurality of fan blades supported on a hub that defines a frontal area. A turbine section drives the fan through a geared architecture about the axis. The fan rotating structure includes a weight of the fan rotating structure relative to the frontal area that enables improvements in engine operating and propulsive efficiencies.

### CROSS REFERENCE TO RELATED APPLICATION

This application is claims priority to U.S. Provisional Application No. 61/708,106 filed on Oct. 1, 2012.

### BACKGROUND

A gas turbine engine typically includes a fan section, a compressor section, a combustor section and a turbine section. Air entering the compressor section is compressed and delivered into the combustion section where it is mixed with fuel and ignited to generate a high-speed exhaust gas flow. The high-speed exhaust gas flow expands through the turbine section to drive the compressor and the fan section. The compressor section typically includes low and high pressure compressors, and the turbine section includes low and high pressure turbines.

A speed reduction device such as an epicyclical gear assembly may be utilized to drive the fan section at a speed different than the turbine section so as to increase the overall propulsive efficiency of the engine. In such engine architectures, a shaft driven by one of the turbine sections provides an input to the epicyclical gear assembly that drives the fan section at a reduced speed such that both the turbine section and the fan section can rotate at closer to optimal speeds.

Although geared architectures have improved propulsive efficiency, turbine engine manufacturers continue to seek further improvements to engine performance including improvements to thermal, transfer and propulsive efficiencies.

### SUMMARY

A gas turbine engine according to an exemplary embodiment of this disclosure, among other possible things includes a fan rotating structure including a plurality of fan blades supported on a hub, a turbine section, and a geared architecture driven by the turbine section for rotating the fan about the axis. A weight of the fan rotating structure is relative to a frontal area of the fan rotating structure is between about 5 lbs/ft² and about 25 lbs/ft².

In a further embodiment of the foregoing gas turbine engine, the weight of the fan rotating structure relative to the frontal area is between about 5 lbs/ft² and about 18 lbs/ft².

In a further embodiment of any of the foregoing gas turbine engines, the weight of the fan rotating structure is relative to the frontal area is between about 6 lbs/ft² and about 16 lbs/ft².

In a further embodiment of any of the foregoing gas turbine engines, the hub includes a fan disk supporting the plurality of fan blades and a hub portion providing a connection to a shaft of the turbine section.

In a further embodiment of any of the foregoing gas turbine engines, the plurality of fan blades including a leading edge fabricated from an aluminum material.

In a further embodiment of any of the foregoing gas turbine engines, the plurality of fan blades include a leading edge fabricated from a material different than aluminum.

In a further embodiment of any of the foregoing gas turbine engines, the plurality of fan blades are fabricated from a composite material.

In a further embodiment of any of the foregoing gas turbine engines, the plurality of fan blades includes a shroud.

In a further embodiment of any of the foregoing gas turbine engines, the speed change system includes a gear reduction having a gear ratio greater than about 2.6.

In a further embodiment of any of the foregoing gas turbine engines, the plurality of fan blades delivers a portion of air into a bypass duct, and a bypass ratio defined as the portion of air delivered into the bypass duct divided by the amount of air delivered into a compressor section is greater than about 6.0.

A method of assembling a fan for a gas turbine engine according to an exemplary embodiment of this disclosure, among other possible things includes attaching a plurality of fan blades to a hub to define a fan rotating structure having a frontal area and a total weight, the total weight of the fan rotating structure relative to the frontal area is between about 5 lbs/ft² and about 25 lbs/ft², supporting the hub about an axis of rotation, and linking a geared architecture driven by a turbine section to the hub for rotating the fan about the axis.

In a further embodiment of the foregoing method, the weight of the fan rotating structure relative to the frontal area is between about 5 lbs/ft² and about 18 lbs/ft².

In a further embodiment of any of the foregoing methods, the weight of the fan rotating structure relative to the frontal area is between about 6 lbs/ft² and about 16 lbs/ft².

In a further embodiment of any of the foregoing methods, the hub includes a fan disk supporting the plurality of fan blades and a portion providing a connection to a shaft of the turbine section.

In a further embodiment of any of the foregoing methods, the speed change system includes a gear reduction having a gear ratio greater than about 2.6.

In a further embodiment of any of the foregoing methods, the turbine engine includes a bypass duct for receiving airflow generated by the plurality of fan blades with a bypass ratio defined as the portion of air delivered into the bypass duct divided by the amount of air delivered into a compressor section that is greater than about 6.0.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example gas turbine engine.

FIG. 2 is a front view of an example gas turbine engine.

FIG. 3 is a perspective view of an example fan blade.

FIG. 4 is a front view of an example shrouded fan.

### DETAILED DESCRIPTION

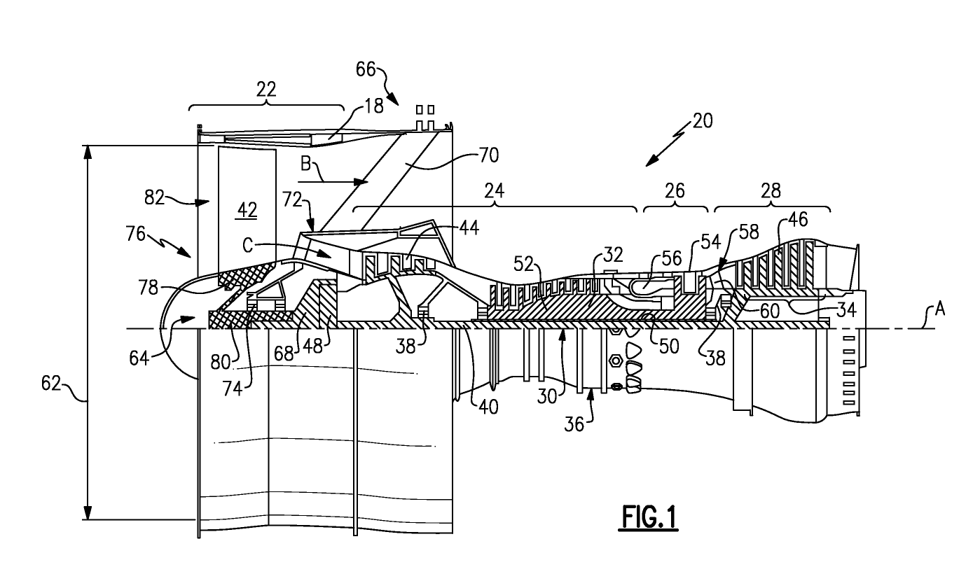

FIG. 1 schematically illustrates an example gas turbine engine 20 that includes a fan section 22, a compressor section 24, a combustor section 26 and a turbine section 28. The fan section 22 drives air along a bypass flow path B while the compressor section 24 draws air in along a core flow path C where air is compressed and communicated to a combustor section 26. In the combustor section 26, air is mixed with fuel and ignited to generate a high pressure exhaust gas stream that expands through the turbine section 28 where energy is extracted and utilized to drive the fan section 22 and the compressor section 24.

Although the disclosed non-limiting embodiment depicts a turbofan gas turbine engine, it should be understood that the concepts described herein are not limited to use with turbofans as the teachings may be applied to other types of turbine engines; for example a turbine engine including a three-spool architecture in which three spools concentrically rotate about a common axis and where a low spool enables a low pressure turbine to drive a fan via a gearbox, an intermediate spool that enables an intermediate pressure turbine to drive a first compressor of the compressor section, and a high spool that enables a high pressure turbine to drive a high pressure compressor of the compressor section.

The example engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided.

The low speed spool 30 generally includes an inner shaft 40 that connects a fan 42 and a low pressure (or first) compressor section 44 to a low pressure (or first) turbine section 46. The inner shaft 40 drives the fan 42 through a speed change device, such as a geared architecture 48, to drive the fan 42 at a lower speed than the low speed spool 30. The high-speed spool 32 includes an outer shaft 50 that interconnects a high pressure (or second) compressor section 52 and a high pressure (or second) turbine section 54. The inner shaft 40 and the outer shaft 50 are concentric and rotate via the bearing systems 38 about the engine central longitudinal axis A.

A combustor 56 is arranged between the high pressure compressor 52 and the high pressure turbine 54. In one example, the high pressure turbine 54 includes at least two stages to provide a double stage high pressure turbine 54. In another example, the high pressure turbine 54 includes only a single stage. As used herein, a “high pressure” compressor or turbine experiences a higher pressure than a corresponding “low pressure” compressor or turbine.

The example low pressure turbine 46 has a pressure ratio that is greater than about 5. The pressure ratio of the example low pressure turbine 46 is measured prior to an inlet of the low pressure turbine 46 as related to the pressure measured at the outlet of the low pressure turbine 46 prior to an exhaust nozzle.

A mid-turbine frame 58 of the engine static structure 36 is arranged generally between the high pressure turbine 54 and the low pressure turbine 46. The mid-turbine frame 58 further supports bearing systems 38 in the turbine section 28 as well as setting airflow entering the low pressure turbine 46.

Airflow through the core flow path C is compressed by the low pressure compressor 44 then by the high pressure compressor 52 mixed with fuel and ignited in the combustor 56 to produce high speed exhaust gases that are then expanded through the high pressure turbine 54 and low pressure turbine 46. The mid-turbine frame 58 includes vanes 60, which are in the core airflow path and function as an inlet guide vane for the low pressure turbine 46. Utilizing the vane 60 of the mid-turbine frame 58 as the inlet guide vane for low pressure turbine 46 decreases the length of the low pressure turbine 46 without increasing the axial length of the mid-turbine frame 58. Reducing or eliminating the number of vanes in the low pressure turbine 46 shortens the axial length of the turbine section 28. Thus, the compactness of the gas turbine engine 20 is increased and a higher power density may be achieved.

The disclosed gas turbine engine 20 in one example is a high-bypass geared aircraft engine. In a further example, the gas turbine engine 20 includes a bypass ratio greater than about six (6), with an example embodiment being greater than about ten (10). The example geared architecture 48 is an epicyclical gear train, such as a planetary gear system, star gear system or other known gear system, with a gear reduction ratio of greater than about 2.6.

In one disclosed embodiment, the gas turbine engine 20 includes a bypass ratio greater than about ten (10:1) and the fan diameter is significantly larger than an outer diameter of the low pressure compressor 44. It should be understood, however, that the above parameters are only exemplary of one embodiment of a gas turbine engine including a geared architecture and that the present disclosure is applicable to other gas turbine engines.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft., with the engine at its best fuel consumption—also known as “bucket cruise Thrust Specific Fuel Consumption (‘TSFC’)”—is the industry standard parameter of pound-mass (1 bm) of fuel per hour being burned divided by pound-force (1 bf) of thrust the engine produces at that minimum point.

“Low fan pressure ratio” is the pressure ratio across the fan blade alone, without a Fan Exit Guide Vane (“FEGV”) system. The low fan pressure ratio as disclosed herein according to one non-limiting embodiment is less than about 1.50. In another non-limiting embodiment the low fan pressure ratio is less than about 1.45.

“Low corrected fan tip speed” is the actual fan tip speed in ft/sec divided by an industry standard temperature correction of [(Tram ° R)/(518.7° R)]^{0.5}. The “Low corrected fan tip speed”, as disclosed herein according to one non-limiting embodiment, is less than about 1150 ft/second.

The example gas turbine engine includes the fan 42 that comprises in one non-limiting embodiment less than about 26 fan blades. In another non-limiting embodiment, the fan section 22 includes less than about 20 fan blades. Moreover, in one disclosed embodiment the low pressure turbine 46 includes no more than about 6 turbine rotors schematically indicated at 34. In another non-limiting example embodiment the low pressure turbine 46 includes about 3 turbine rotors. A ratio between the number of fan blades 42 and the number of low pressure turbine rotors is between about 3.3 and about 8.6. The example low pressure turbine 46 provides the driving power to rotate the fan section 22 and therefore the relationship between the number of turbine rotors 34 in the low pressure turbine 46 and the number of blades 42 in the fan section 22 disclose an example gas turbine engine 20 with increased power transfer efficiency.

Moreover, example embodiments of the disclosed geared turbofan engine include a light weight fan rotating structure that enables reductions in overall engine weight, pylon weight, wing structure weight and overall engine operating efficiency.

Referring to FIG. 2 with continued reference to FIG. 1, an example fan rotating structure 76 includes the fan blades 42 attached to a hub 64. The hub 64 includes a one piece fan disk 78 to which the blades 42 attach and a hub portion 80 that is engaged to a drive shaft 68 driven by the geared architecture 48. The fan rotating structure 76 includes a diameter 62 between tips 84 of the fan blades 42. A frontal area 82 of the fan rotating structure 76 is determined utilizing the diameter 62 measured between tips 84 of the fan blades 42. In this example, frontal area 82 is referred to in units of cubic feet (ft²).

| | SL | | fan | number | blade | | entire fan rotr wt | Fan | Fan wt |
|---|---|---|---|---|---|---|---|---|---|
| | RATED | Fan | blade wt | of | set wt | fan hub | (inc hub & full | Area | (lb)/t\hat{ }2 |
| ENGINE | Thrust | Dia | (lbs) | blades | (lbs) | wt | set of blades) | (in\hat{ }2) | frontal area |
| 1 | 28000 | 81 | 12.40 | 20 | 249.8 | 100 | 350 | 5153 | 10.0 |
| 2 | 23000 | 73 | 11.27 | 18 | 202.86 | 127 | 330 | 4185 | 11.3 |
| 3 | 17000 | 56 | 8.34 | 18 | 105.12 | 74.14 | 224 | 2463 | 13.1 |
| 4 | 84000 | 112 | 31.32 | 22 | 755.04 | 562 | 1317 | 9852 | 19.3 |
| 5 | 82000 | 94 | 12.28 | 38 | 466.64 | 450 | 917 | 6940 | 19.0 |
| 6 | 58000 | 94 | 12.28 | 38 | 466 64 | 450 | 917 | 6940 | 19.0 |
| 7 | 37000 | 77 | 8.91 | 36 | 320.76 | 203.6 | 524 | 4698 | 16.1 |
| 8 | 28000 | 63 | 9.6 | 22 | 211.2 | 254 | 465 | 3117 | 21.5 |
| 9 | 28000 | 63 | 9.6 | 22 | 211.2 | 211.2 | 422 | 3117 | 19.5 |

The hub 64 and fan blades 42 are fabricated to provide a reduced weight that improves overall engine efficiency. The increased efficiency is enabled by the large bypass ratios provided in view of a reduction in weight of the fan rotating structure 76. The improved efficiency enabled by the lighter fan rotating structure 76 is characterized as a relationship of weight of the fan rotating structure 76 to the frontal area 82 represented as pounds per cubic feet (lbs/ft²). One example fan rotating structure embodiment is fabricated to provide a weight relative to unit of frontal area 82 that is between about 5 lbs/ft² and about 25 lbs/ft².

The example disclosed geared turbofan engine 20 enables relatively improved turbofan bypass ratios compared with that in typical modem engines. A high bypass ratio and low fan pressure ratio is desirable because it has the potential to reduce fuel burn, and is realized due to the larger diameter of the fan blades 42 that have a characteristic of weight versus fan frontal area 82 that enables favorable engine configurations.

### Table 1

Several example gas turbine engine embodiments and features of corresponding fan rotating structures 76 are provided in Table 1. The example disclosed range of weight per unit of frontal area 82 (lbs/ft²) is enabled by fan rotating structures 76 within the scope and contemplation of this disclosure. The weight of all the fan blades 42 is combined with the weight of the hub 64 to define an overall weight of the fan rotating structure 76. The frontal area 82 is determined utilizing the fan diameter 62 between opposing fan tips 84.

A disclosed geared turbofan engine within the contemplation of this disclosure is within a range of weight to frontal area between about 6 lbs/ft² and about 18 lbs/ft². In another disclosed range, the fan rotating structure 76 includes a weight to frontal area relationship as low as about 8 lbs/ft². In still another embodiment of this disclosure the fan rotating structure includes a weight of the fan rotating structure 76 relative to the frontal area between about 5 lbs/ft² and about 16 lbs/ft². Previous engine architectures included relationships of weight per square foot ranges as high as or higher than about 21.5 lbs /ft2.

Moreover, the reduced weight of the fan rotating structure 76 provides additional benefits by reducing the weight of the supporting structures 66. In the disclosed example, the supporting structure 66 includes the fan case 18, structural guide vanes 70, a forward case structure 72 and bearing support structure 74.

Reduced loads enabled by the reduced weight of the fan rotating structure 76 provide a corresponding reduction in fan blade out loads, and thereby the supporting structure 66 required to absorb such loads may be fabricated as lighter components. Additionally, the reduced weight of the support structure 66 and the fan rotating structure 76 enables reduced weight of airframe structures such as for example, the pylon and wing box (not shown) supporting the engine. The reduction in weight resulting from the reduced weight of the fan rotating structure extends through the mounting structures and also provides favorable and improved overall engine weight and center of gravity (CG) characteristics.

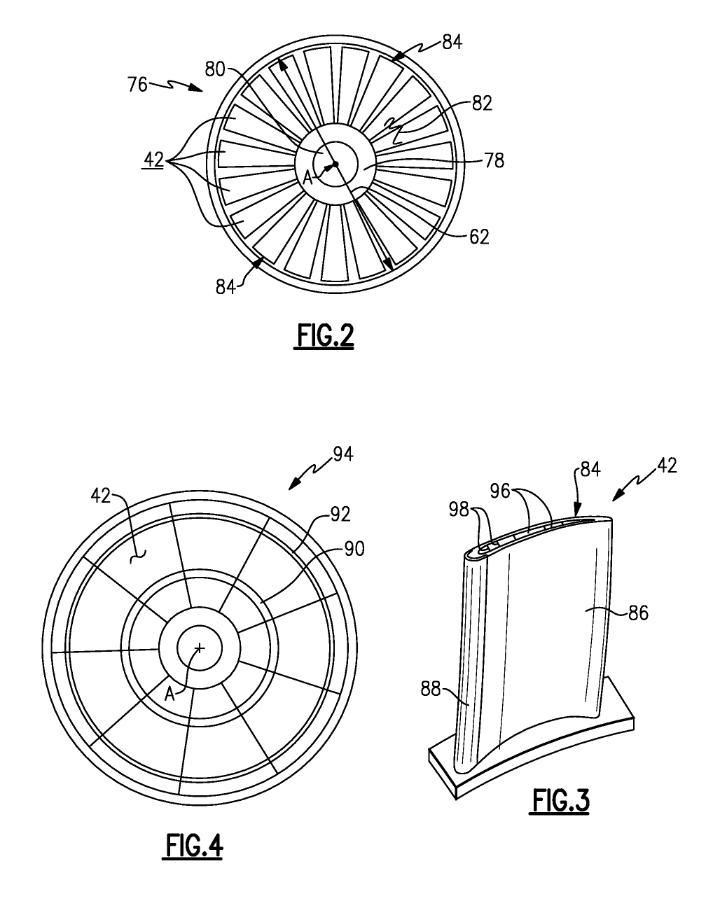

Referring to FIG. 3, with continued reference to FIGS. 1 and 2, features enabling the example geared turbofan engine with a bypass ratio of greater than 6.0 and a gear ratio greater than 2.6 to provide a fan structural weight relative to the frontal area 62 of less than about 16 lbs/ft² include for example, fabricating the fan blades 42 from an aluminum material. In this example, the fan blade 42 includes a body portion 86 fabricated from an aluminum material. The example fan blade 42 may also be fabricated from a composite material including a metal leading edge 88.

The metal leading edge 88 can be fabricated from a material other than aluminum such as titanium, nickel, or composites or alloys or other materials that provide improved leading edge performance compared to aluminum. Furthermore, the example fan blades 42 are also lighter by providing inner cavities 96, disposed between strengthening ribs 98.

Referring to FIG. 4, with continued reference to FIG. 1, another example fan structure 94 is disclosed that further enables low fan structural weight. The example fan structure 94 includes a mid-span shroud 90 that increases rigidity to enable lighter weight fan blade structures. Moreover, an outer or full span shroud 92 could be utilized in combination with the mid-span shroud 90 are by itself to further increase structural rigidity while enabling the use of lighter weight fan blade structures. Lighter weight fan blade structures enable lower weights of the fan rotating structure 76 to provide overall improvements in engine operating efficiencies.

Accordingly, engine configurations within the scope of this disclosure enable the disclosed fan weight to frontal area values. Moreover, the disclosed fan weight to frontal area values enable a power intensity related to the rated thrust to provide advantageous overall engine propulsive efficiencies.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. A gas turbine engine comprising:
a fan rotating structure including a plurality of fan blades supported on a hub;
a turbine section; and
a geared architecture driven by the turbine section for rotating the fan about the axis, wherein a weight of the fan rotating structure relative to a frontal area of the fan rotating structure is between about 5 lbs/ft² and about 25 lbs/ft².

2. The gas turbine engine as recited in claim 1, wherein the weight of the fan rotating structure relative to the frontal area is between about 5 lbs/ft² and about 18 lbs/ft².

3. The gas turbine engine as recited in claim 1, wherein the weight of the fan rotating structure relative to the frontal area is between about 6 lbs/ft² and about 16 lbs/ft².

4. The gas turbine engine as recited in claim 1, wherein the hub includes a fan disk supporting the plurality of fan blades and a hub portion providing a connection to a shaft of the turbine section.

5. The gas turbine engine as recited in claim 1, wherein the plurality of fan blades including a leading edge fabricated from an aluminum material.

6. The gas turbine engine as recited in claim 5, wherein the plurality of fan blades include a leading edge fabricated from a material different than aluminum.

7. The gas turbine engine as recited in claim 1, wherein the plurality of fan blades are fabricated from a composite material.

8. The gas turbine engine as recited in claim 1, wherein the plurality of fan blades includes a shroud.

9. The gas turbine engine as recited in claim 1, wherein the speed change system comprises a gear reduction having a gear ratio greater than about 2.6.

10. The gas turbine engine as set forth in claim 1, wherein the plurality of fan blades delivers a portion of air into a bypass duct, and a bypass ratio defined as the portion of air delivered into the bypass duct divided by the amount of air delivered into a compressor section is greater than about 6.0.

11. A method of assembling a fan for a gas turbine engine comprising:
attaching a plurality of fan blades to a hub to define a fan rotating structure having a frontal area and a total weight, wherein the total weight of the fan rotating structure relative to the frontal area is between about 5 lbs/ft² and about 25 lbs/ft²;
supporting the hub about an axis of rotation; and
linking a geared architecture driven by a turbine section to the hub for rotating the fan about the axis.

12. The method as recited in claim 11, wherein the weight of the fan rotating structure relative to the frontal area is between about 5 lbs/ft² and about 18 lbs/ft².

13. The method as recited in claim 11, wherein the weight of the fan rotating structure relative to the frontal area is between about 6 lbs/ft² and about 16 lbs/ft².

14. The method as recited in claim 11, wherein the hub includes a fan disk supporting the plurality of fan blades and a portion providing a connection to a shaft of the turbine section.

15. The method as recited in claim 11, wherein the speed change system comprises a gear reduction having a gear ratio greater than about 2.6.

16. The method as recited in claim 11, wherein the turbine engine includes a bypass duct for receiving airflow generated by the plurality of fan blades with a bypass ratio defined as the portion of air delivered into the bypass duct divided by the amount of air delivered into a compressor section that is greater than about 6.0.
